(19) United States
(12) Patent Application Publication
(10) Pub. No.: US 2006/0241522 A1
(43) Pub. Date: Oct. 26, 2006

(54) Ultrasound devices and methods for treating ischemia and other cardiovascular disorders

(76) Inventor: Premindra Anthony Chandraratna, Rancho Palos Verdes, CA (US)

Correspondence Address: Premindra A Chandraratna, 30932 Marne Drive, Rancho Palos Verdes, CA, 90275, US

(21) Appl. No.: 10/562,129

(22) PCT Filed: Jun. 18, 2004
(86) PCT No.: PCT/US04/19498

§ 371 Date: Dec. 15, 2005

Related U.S. Application Data
(60) Provisional application No. 60/479,416, filed on Jun. 18, 2003.

(51) Int. Cl. A61H 1/00

(52) U.S. Cl. 601/2

(57) ABSTRACT

Therapeutic ultrasound devices and methods are provided. The device (10) generally includes a substrate, for example, a flexible substrate (14), and multiple, individual transducer elements (16a, 16b, 16c) disposed on a face (18) of the substrate (14). The device may be provided as a part of an ultrasound system for that includes a generator unit and a controller including drive electronics. The device and method is especially useful for the treatment of ischemia and hypoxia using ultrasound levels that are generally no greater than those used for diagnostic purposes.

### RELATED APPLICATIONS

This application claims priority to U.S. Provisional Patent Application No. 60/479,416, filed on Jun. 18, 2003, the entirety of which is expressly incorporated herein by reference.

### BACKGROUND

The present invention generally relates to a medical device for treatment of iscemia and more particularly to an ultrasonic device for treatment of iscemia and related disorders.

Ultrasound technology is widely used for imaging various organs in the body and for diagnosis of tissue pathology. A variety of ultrasound transducer devices are currently available for imaging specific areas of the body. These transducer devices vary in size, shape and operating frequency, depending on the age, body size of the patient, and the organ that has to be imaged.

An ultrasound examination is typically performed by placing an ultrasonic transducer device on the body surface of the patient. Transducers may also be placed in a body cavity such as the rectum and the vagina, to image various abnormalities in these structures. More recently, transesophageal echocardiography has been performed by mounting a transducer at the tip of a gastroscope and introducing the transducer it into the esophagus.

More specifically, ultrasound examinations are typically performed by placing an ultrasonic probe containing a transducer onto the surface of the patient's body, usually utilizing a coupling medium between the probe and the skin, and transmitting acoustic waves from the probe into the body in order to obtain an image of a slice of the internal structures of a region of the body for diagnostic purpose. Chandraratna, et al., U.S. Pat. No. 5,598,845, the entire disclosure of which is incorporated herein by this specific reference, describes a low profile transducer, which is designed to be attached to the chest wall in order to provide continuous imaging of the heart.

Ultrasonic energy is known to be useful for treating the body as well as for imaging/diagnostic purposes. Mandrusov et al., U.S. Pat. No. 6,740,040, the entire disclosure of which is incorporated herein by this specific reference, describes a method and apparatus for improving blood flow to an ischemic region in a patient. The patent discloses that this is accomplished by utilizing focused acoustic energy to create one or more specifically placed thermal lesions in the ischemic region of the myocardium.

Mason, U.S. Pat. No. 6,428,477, the entire disclosure of which is incorporated herein by this specific reference, describes a method for both imaging a region and providing therapeutic treatment to a patient by utilizing a focused, scanned beam of ultrasonic energy. Mason discloses that the ultrasound energy is delivered at an intensity suitable for heating tissue or for bursting microspheres in microsphere-encased pharmaceuticals. Sharply focused echoes are reflected and detected and used to create an ultrasound image. These methods and devices are generally directed at utilizing focused beams of ultrasound to heat tissue and are not suitable for exposing large areas or volumes of a body region to ultrasound.

Vasculogenesis is the in situ formation of blood vessels from endothelial progenitor cells. In contrast, angiogenesis is the process of extension of already formed primitive vasculature by sprouting of new capillaries by migration and proliferation of previously differentiated endothelial cells. Hypoxia or ischemia, secondary to arterial occlusion is the biological stimulus for endogenous angiogenesis. There is increased expression of vascular endothelial growth factor (VEGF) in response to hypoxia, which results in angiogenesis.

Collateral vessels develop in response to a high-grade stenosis or occlusion of a coronary artery. These vessels may provide sufficient blood flow to preserve left ventricular function and prevent or minimize symptoms related to myocardial ischemia. Enhancement of this process by delivery of angiogenic growth factors to promote neovascularization may therefore be a useful therapeutic strategy. Intracoronary injection of VEGF in animals and man, has been shown to promote angiogenesis and promote myocardial blood flow.

Therapeutic angiogenesis has been proposed, which generally involve intra-coronary or intra-myocardial injection of angiogenic growth factors or gene transfer. These methods are expensive and may be associated with complications.

There remains a need in the art for the development of new ultrasonic instruments, devices, apparatus and methods that utilize the beneficial properties of ultrasound energy for therapeutic purposes, especially for promoting angiogenesis in ischemic tissue, for example, ischemic tissue in a heart, extremity, or other body organ or body region.

### SUMMARY OF THE INVENTION

The present invention provides ultrasound devices and methods, for example, but not limited to therapeutic ultrasound devices for stimulating angiogenesis and/or relieving ischemia in a human or veterinary patient.

An ultrasound device in accordance with one embodiment of the present invention generally comprises, consists essentially of, or consists of; a substrate, for example, a flexible substrate, and multiple, individual transducer elements disposed on the substrate, for example a face of the substrate. The device may be provided as a part of an ultrasound system for that includes a generator unit and a controller including drive electronics. For example, in some embodiments of the present invention, the device or system is structured to enable individual control over each of the ultrasound transducer elements in order to allow a physician or technician to provide the most effective individualized treatment to a patient. The device may include means for connecting the transducer elements to a specially designed drive system, which can activate the transducers simultaneously or in one or more different sequences.

For example, the device may be structured to be connectable to an external signal generator and drive electronics for driving the transducer elements individually, as a single group, or as individual sets of multiple transducer elements. Thus, the device may be designed such that individual transducer elements can be driven simultaneously, in a preprogrammed sequence, and/or in another manner selected by the physician or technician.

In one embodiment of the present invention, the device is in the form of a flexible “quilt” having the individual transducer elements embedded in a spaced apart relationship within a face of a flexible substrate. The quilt device may be sized, structured or otherwise adapted to be placed on a body surface of a patient such that the transducers are positioned to radiate therapeutic ultrasound into a target body region, for example, the myocardium.

The ultrasound transducer quilt in accordance with the present invention is designed to be placed or positioned on the chest wall. Typically, a coupling medium, such as an ultrasonic gel, will be used to interface the transducers and the body surface of the patient. The quilt may be configured to cover a suitably sized area of the chest in some embodiments, and in other embodiments the quilt may be configured to cover a suitably sized area of the lower extremity of the patient, for example the calf, in order to effectively deliver ultrasonic energy to stimulate angiogenesis in the heart or lower extremities, respectively.

In some embodiments of the invention, the device may be designed to be useful for providing non-invasive thrombolysis and/or for providing therapy aimed at preventing restenosis.

In some embodiments of the present invention, a device is provided that comprises a formable or moldable element that is made substantially entirely of an ultrasound generating material, for example piezoelectric ceramic material. For example, the device may comprise a piezoelectric ceramic element that is shaped to conform to a body surface overlying a body region to be treated. The piezoelectric ceramic element may be designed to be entirely conductive of ultrasound energy, for example from a face of the device, or alternatively/additionally, may include one or more discrete areas of ultrasound transmission capability.

The following patents and publications include disclosure which may be relevant to and/or helpful in understanding the present invention: Sheramn et al., U.S. Pat. No. 5,735,280; Mason, U.S. Pat. No. 6,428,477; Peterson et al. , U.S. Pat. No. 5,879,314; Bolomey et al., U.S. Pat. No. 6,424,597; Questo, U.S. Pat. No. 4,505,156; Merewether, U.S. Pat. No. 6,097,671; Umemura et al., U.S. Pat. No. 4,604,543; Mandrusov et al., U.S. Pat. No. 6,740,040; O'Donnell, U.S. Pat. No. 5,142,649; Hooker, M. W., “Properties of PZT-Based Piezoelectric Ceramics Between −150 and 250° C.” NASA CR 208708, 1998; Jinhao, Q. et al, “Fabrication of Piezoelectric Ceramic Fibers by Extrusion of Pb(Zr, Ti)O₃ Powder and Pb(Zr, Ti)O₃ Sol Mixture” IoP Electronic Journals, Apr. 28, 2003;

The present invention may be more clearly understood and objects and advantages thereof may be better appreciated with reference to the following detailed description and accompanying drawings.

### BRIEF DESCRIPTION OF THE DRAWINGS

FIG. 1 is a perspective view of a device in accordance with the present invention, as fastened to a chest of a human patient, the device being used to radiate therapeutic ultrasound into an ischemic region of the heart.

FIG. 2 is a cross sectional view of the device and patient shown in FIG. 1.

FIG. 3 is a perspective view of another embodiment of the device in accordance with the present invention, as fastened to a calf of a human patient, the device being used to radiate ultrasound Into the calf to promote angiogenesis or other effects therein.

FIG. 4 shows an embodiment of the invention wherein the device is made substantially entirely of a formable/moldable ultrasound transmitting material, configured to be placed on a chest of a patient.

FIG. 5 shows another embodiment of the invention similar to the embodiment shown in FIG. 4, wherein the device is configured to be placed on a calf of a patient.

### DETAILED DESCRIPTION OF THE INVENTION

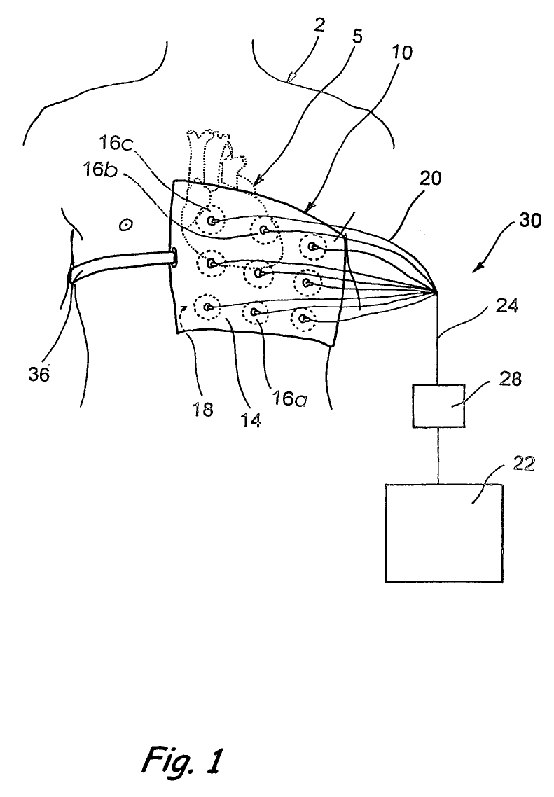

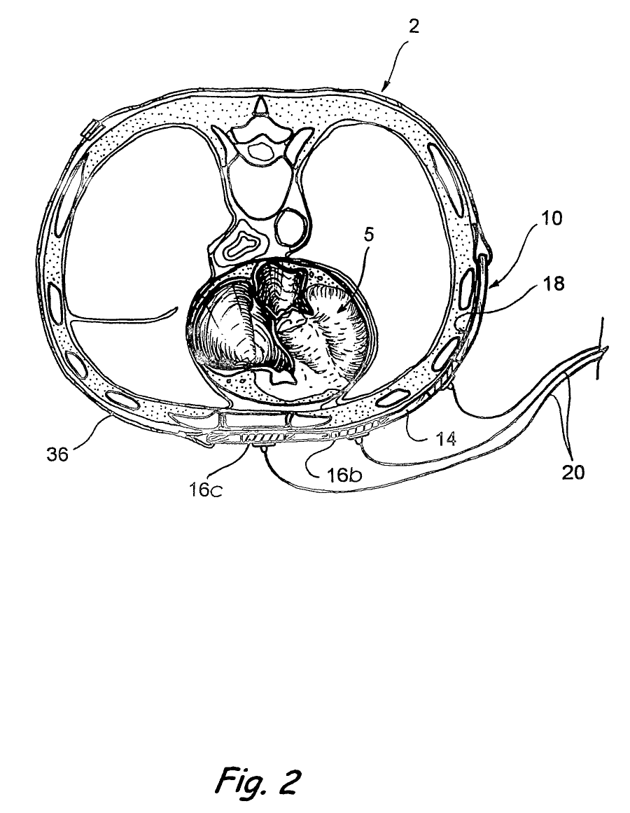

Turning now to FIGS. 1 and 2, a device in accordance with the present invention for treating a human or veterinarian patient 2 is shown generally at 10.

In this particular embodiment of the invention, the device 10 generally comprises a flexible substrate 14 made of a fabric, netting, film, sheet, or other material, and a plurality of ultrasound transducer elements 16a, 16b, positioned on a face 18 of the substrate 14. The substrate 14 is a material that is acoustically inert in that it does not provide any substantial transmission of ultrasound upon the device 10 being activated.

The plurality of ultrasound transducer elements 16a, 16b, 16c, may comprise any suitable number of such elements 16a, 16b, 16c, for example about 2 to about 20 or more transducer elements 161, 16b, 16c. In use, the transducer elements 16a, 16b, 16c are coupled to the body surface with a coupling medium, for example a coupling gel, for enhancing coupling of the ultrasound energy to the body. Operation frequencies of the transducer elements 16a, 16b, 16c will typically be in the range of between about 1.6 MHz to about 8 MHz and/or about 40 KHz to about 400 KHz.

Means, such as transmission lines 20, for example, connected to a common lead 24, are provided for coupling the device 10 to an ultrasound generator unit 22 which includes a generator for driving the transducer elements 16a, 16b, 16c. The generator unit 22 may be operable by standard 110v AC 50/60 Hz, but may be modified to accommodate any line voltage. The entire device 10 may be designed to be under computer or microcontroller (stand-alone) control. For example, the drive electronics 28 may be configured such as to enable automatic or manual switching of one or more of the transducer elements 16a, 16b, 16c on at a given time, for example by means of a mechanical reed relay or electronic switch. If only one element is turned on at a given time then the maximum acoustic power level may be kept relatively low. The power may be is kept at or below FDA diagnostic ultrasound limits.

In this particular embodiment of the invention, the device 10 is in the form of a flexible “quilt” designed to flexibly and adjustably conform to a body surface of the patient, for example the chest, in order to provide ultrasound from one or more of the transmitter elements 16a, 16b, 16c, into a region of the heart 5. Thus, the device 10, in a sense, has a deformable, ultrasound emitting surface. By varying the size and number of transducer elements 16a, 16b, 16c, the device 10 can be made to have a deformable ultrasound emitting surface that can radiate ultrasound into a surface of highly varying contour.

The device 10 may be a part of a larger therapeutic ultrasound system 30 in accordance with the invention, wherein the system 30 includes the device 10, a generator unit 22 as well as drive electronics 28 or other suitable means for enabling individual control of the transducer elements 16a, 16b, 16c. For example, in some embodiments of the invention, the device 10 and/or system 30 may be structured to enable individual transducers 16a, 16b, 16c, to be selectively driven, for example in accordance with a preprogrammed timing sequence. For example, the device 10 or system 30 may be structured to enable transducers 16b and 16c to provide continuous or pulsed ultrasonic energy to the heart while transducer 16a is essentially not transmitting ultrasonic energy.

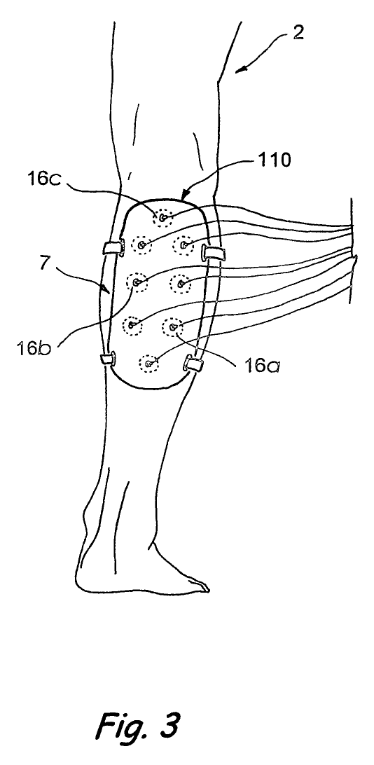

In this regard, for example, the ultrasound quilt device 10 may be placed upon the chest of a human or veterinary patient as shown in FIG. 1, and may be held in place by straps 36, adhesive or any other suitable means. The ultrasound transducer elements 16a, 16b, 16c, may then be energized to deliver ultrasound, continuously or intermittently, to an area of an organ (such as the heart 5 or other body part (such as the calf 7 shown in FIG. 3,) for a sufficient time to bring about a desired ultrasound-induced effect, for example, consequent relief of myocardial or leg ischemia.

In addition, the transducer elements 16a, 16b, 16c may be in communication with drive electronics 28 and/or a programmable controller (such as a microprocessor or computer) which can switch one or more elements, for example elements 16a, 16b and 16c, on and/or off and/or to alter the power delivered to individual transducer element(s), at desired time(s), to bring about the desired ultrasound-induced effect. For example, the transducer elements 16a, 16b, 16c may be operated in such a way as to pulse the elements 16a, 16b, 16c in a pattern so as to create a desired focal plane or focal region of ultrasound energy in the treatment area. In some instances, the elements 16a, 16b, 16c may be selectively operated to create a variable, moving wave of ultrasound energy. Various types of scans that are used in diagnostic ultrasound procedures may be applied to the individual transducer elements 16a, 16b, 16c, groups of the transducer elements 16a, 16b, 16c, or all of the transducer elements 16a, 16b, 16c in order to promote angiogenesis or provide other therapeutic treatment in accordance with the present invention.

The ultrasound transducer elements 16a, 16b, 16c, may each comprise piezoelectric (ceramic) elements capable of emitting a beam of ultrasonic radiation, for example, each of the elements 16a, 16b, 16c may comprise a rigid PZT-based piezoelectric ceramic element. Such materials and methods for making such individual transducer elements having desirable properties for insonating tissue are well known in the art.

The device 10 may be structured to enable selective control of focusing of ultrasonic energy from the device 10 such that an area or volume of insonation emitted by the device 10 will substantially match the area or volume of the structure or tissue of the body to be treated. In this respect, the device 10 may be operated as needed for a specific, desired mode of treatment. For example, the device 10 may be operated to cause or promote neovascularization in a discrete zone of the myocardium by operating the device 10 to create a narrow, focused beam of ultrasound energy directed at the area to be treated. Alternatively, a broad, substantially unfocused beam of uniform or non-uniform insonation may be used to promote neovascularization in a relatively wider zone of the heart or other body structure. In some embodiments of the invention, the transducer elements 16a, 16b, 16c, may be capable of delivering acoustic energy at one or more discrete frequencies.

Moreover, the present device 10 of the invention may be used as an effective therapeutic tool to treat various disorders. Methods of using the device to treat these various disorders are included within the scope of the present invention. In some embodiments of the invention, the device 10 is used to promote angiogenesis and neovascularization to treat hypoxia or ischemia. The device 10 is also effective in promoting the production or expression of vascular endothelial growth factor (VEGF) and/or other beneficial endogenous factors or substances.

The device 10 may also be used in conjunction with therapeutic (e.g., medicinal or diagnostic) agents. It has been found that low frequency ultrasound has the effect of accelerating activity of certain agents, for example, thromobolytic agents injected near the site of an occlusion in an artery. Also, ultrasound may alter (through vasodilation, changes in membrane permeability or other mechanisms) the biodistribution and/or localized tissue concentrations of certain substances such as drugs, exogenous or endogenous agents, etc. Ultrasound therapy by means of the present device 10 may have a synergistic or supra-additive effect on such medicinal agents and consequently, a lower dosage of medicinal agent coupled with ultrasound therapy can be used as a substitute for conventional therapies which rely primarily on the use of drugs alone. Consequently, it is possible to minimize the amount of medicinal agent administered, and thus reduce undesirable side effects that may be attributable to the agent. In this respect, the benefits of the ultrasound therapy provided by the device 10 may be sufficient to require a relatively lower dose of a pharmaceutical drug, in order to achieve equivalent or superior results than that available with treatment by the pharmaceutical drug without ultrasound therapy.

In some embodiments, the ultrasound emitted by the device 10 may act upon a substance (e.g., a drug, biological, gene therapy preparation, cells or blasts, etc.) or substance delivery vehicle (e.g., polymer, microcapsules, lyposomes, etc.) that has been administered to the patient to cause localized release and/or activation of the substance. Such localized release or activation of the substance may facilitate targeted therapy and may minimized untoward or toxic effects of the substance at other locations in the body.

In some embodiments, all of the transducer elements 16a, 16b, 16c may emit ultrasound at the same time and/or in the same manner (e.g., all continuous or all pulsed with same pulse duration and same duty cycle) and/or at the same or substantially the same frequency. In other embodiments, it may be desirable to cause one or more of the transducer elements 16a, 16b, 16c to emit ultrasound at different time(s), in different manner(s) (e.g., one or more continuous and one or more others pulsed/one of more at one pulse duration or duty cycle and one or more other(s) at different pulse duration(s) or duty cycle(s) and/or at different frequencies. In this regard, the frequency of the ultrasound may be adjusted on some or all of the transducer elements 16a, 16b, 16c to provide a desired localized depth of penetration into the body and/or other localized variations in effect. Ultrasound within a first frequency range of about 40 KHz to about 400 KHz may be employed where a relatively deep depth of penetration is desired and ultrasound within a second frequency range of about 1.6 MHz to about 8 MHz may be employed where a more shallow depth of penetration is desired.

It can be appreciated that the ultrasound transducer quilt device 10 is non-invasive, exposes a large area or volume of the heart 5 or other body structure to therapeutic levels of ultrasonic energy, is relatively inexpensive, widely applicable and is likely to have few if any substantial side effects. Importantly, repeated application of the device 10 is feasible. It is noted that the devices and methods of the present invention are effective in treating such disorders as ischemia and hypoxia, using low levels of ultrasound energy, such as ultrasound levels that are generally no greater than those used for diagnostic purposes. Thus, thermal and/or other damage to tissues is substantially prevented or avoided.

Turning now to FIG. 2, a cross section of the chest is shown with the device 10 of the present invention attached to the chest wall to expose the heart muscle (left ventricular myocardium) to ultrasound energy for a period of time sufficient to promote angiogenesis and relieve ischemia in the muscle. The treatment period may be an uninterrupted time period lasting several minutes, one hour, two hours, up to four hours or more, or may comprise multiple relatively shorter time periods of treatment separated by periods of rest wherein no ultrasound is radiated into the patient.

The size of the device 10, and the dimensions and/or spacing of the transducer elements 16a, 16b, 16c, in the device 10 may vary, within the scope of the present invention, depending upon a desired course of treatment, patient size, and/or body part of the patient to which the device is to be fitted.

For example, FIG. 3 shows another ultrasound device 110 for treating a patient, in accordance with the present invention. Except as expressly described herein, device 110 is similar to device 10 and features of device 110 which correspond to features of device 10 are designated by the corresponding reference numerals increased by 100.

Device 110 is substantially similar to device 10 with the exception that the size, shape of the device 110 are configured, and the number and spacing of the transducer elements 16a, 16b, 16c are selected, such that the device 110 is adapted for treatment of vessel and tissue disorders in a calf 7 of the patient 2.

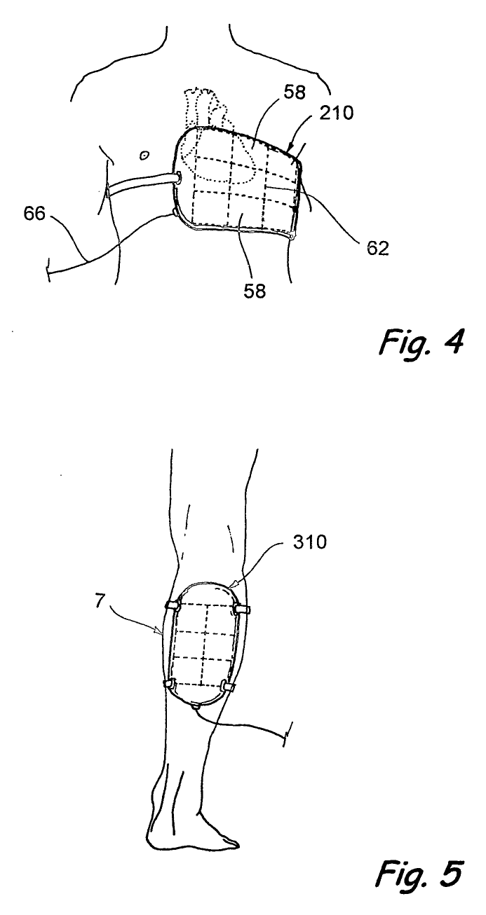

Turning now to FIG. 4, a device 210 in accordance with another embodiment of the present invention is shown, as fastened to a chest of a patient 2. Except as expressly described herein, device 210 is similar to device 10 and features of device 210 which correspond to features of device 10 are designated by the corresponding reference numerals increased by 200.

Device 210 generally comprises a plurality of ultrasound transducer elements comprising ultrasound emitting plates 58, flexibly or rigidly coupled together. For example, the plates 58 may be coupled by means of flexible hinged regions (indicated by dashed lines 62) comprising a flexible polymer adhered between adjacent plates 58.

In some embodiments of the invention, the plates 58 comprise a piezoelectric ceramic material, for example Pb(Zr, Ti)O₃ (PZT) piezoelectric ceramic, which may be fabricated by means known in the art. For example, each plate 58 may be made by cutting a strip of PZT material into individual squares. Alternatively, individual plates 58 may be fabricated by molding, extruding or otherwise forming each plates from a PZT precursor material.

In the embodiment of the invention shown in FIG. 4, each plate 58 is about 2 inches by about 2 inches in size. An electrically conductive line (not shown) electrically coupling all or some of the plates 58 together may be provided and insulated within the flexible hinged regions 62, wherein each line is connected to a single cable 66. Alternatively, each plate 58 may include a discrete conductive line for coupling the plate 58 to a common power source.

In some embodiments of the invention, the device 210 does not include flexible hinges 62, but instead the device 210 comprises a unitary, substantially rigid element preformed to fit to a body surface of a patient. In this manner, the unitary rigid element may be molded or otherwise formed of a single piece of piezoelectric ceramic having one or more discrete areas capable of ultrasound energy transmission.

FIG. 5 shows another embodiment of the invention wherein the device 310 is substantially the same as the device 210 with the exception that the device 310 is configured to be used for treatment of a human calf 7 such as described elsewhere herein with respect to device 110.

Further in accordance with the present invention, there are provided methods for using an ultrasound device of the foregoing character to cause angiogenesis or to treat ischemia in a human or veterinary patient. In this regard, a device, for example a device similar or identical to the devices of the invention described and shown herein, may be positioned on a portion of the body (e.g., a thorax) such that the transducer elements will deliver ultrasound to a portion of the body that is ischemic or in which it is desired to stimulate angiogenesis (e.g., the myocardium). The transducer elements are then energized and operated to deliver ultrasound to the desire body part (e.g., myocardium) for sufficient time to induce angiogenesis and/or relieve or deter ischemia. For example, the transducers elements may be operated simultaneously, alternately, in a phased, patterned sequence, or other mode of operation, for a period of time sufficient to enhance production or expression of vascular endothelial growth factor (VEGF) in the region being insonated.

For example, the method may comprise comprises operating a plurality of the transducer elements to produce an ultrasound-induced effect, for example angiogenesis, within the body, in order to provide treatment, for example in order to prevent and/or relieve ischemia. In accordance with one embodiment of the invention, the ultrasound device is positioned on the chest and used to promote angiogenesis in the heart for relief of myocardial ischemia. For example, the method may comprise treating the patient with the ultrasound device when the patient is presenting with ST segment changes or other clinical or biochemical indicia of myocardial infarction. In another example, the method may comprise treating a patient who suffers from dilated cardiomyopathy such that the method would promote angiogenesis and/or improve left ventricular function such as by way of inducing elevation in levels of certain endogenous substances such as VEGF etc.

The method may comprise positioning the device on at least one extremity of a patient who suffers from diabetic neuropathy or other neuropathy, and operating the device such as to promote angiogenesis and/or relieve pain resulting from such neuropathy.

In yet other embodiments of the invention, the ultrasound device is operated in a manner such as to be effective in causing thrombolysis in a patient. The method may comprise utilizing the ultrasound device for preventing restenosis after angioplasty and/or stent placement in a coronary artery or other vessel.

The present invention may comprise treating a patient using a device such as described herein, comprising positioning or placing the device on the patient's calf and the device operated such as to be effective in promoting angiogenesis, relieving myocardial ischemia and/or intermittent claudication or other ischemic condition of the leg.

In accordance with the present invention, the transducer elements may be operated simultaneously, or substantially simultaneously, for a time period having a length of between about one hour and about 4 hours. The transmission of ultrasound energy from the transducer elements may be continuous or pulsed in order to provide less heating of tissue.

It is believed that the ultrasound devices in accordance with the present invention, for example devices 10, 110, 210, 310, are suitable for delivery of ultrasound, to a substantial area or volume of a body organ, or body part for a prolonged period of time to promote angiogenesis or other therapeutic purposes such as described elsewhere herein.

The invention has been described herein with reference to certain examples and embodiments only. No effort has been made to exhaustively describe all possible examples and embodiments of the invention. Indeed, those of skill in the art will appreciate that various additions, deletions, modifications and other changes may be made to the above-described examples and embodiments, without departing from the intended spirit and scope of the invention as recited in the following claims. It is intended that all such additions, deletions, modifications and other changes be included within the scope of the following claims.

What is claimed is:

1. A therapeutic ultrasound device comprising:
a substrate having a face and configured to be positionable on a body surface of a human or veterinary patient; and
a plurality of ultrasound transducer elements disposed on the face of the substrate;
the device being structured to be effective to deliver ultrasound energy to at least an organ or portion of the patient's body for a sufficient time to stimulate angiogenesis and/or relieve ischemia.

2. An ultrasound device according to claim 1 wherein the substrate comprises a flexible sheet.

3. An ultrasound device according to claim 1 further comprising drive electronics for controlling operation of at least some of the transducer elements.

4. An ultrasound device according to claim 1 wherein the transducer elements comprise piezoelectric ceramic material.

5. An ultrasound device according to claim 1 wherein the transducer elements comprise PZT.

6. The ultrasound device according to claim 1 wherein the transducer elements are rigidly connected together.

7. The ultrasound device according to claim 1 being configured to cover a portion of a human chest.

8. The ultrasound device according to claim 1 being configured to cover a portion of a human leg.

9. A method for causing an ultrasound-induced effect within the body of a human or veterinary patient, said method comprising the steps of:
positioning an ultrasound device including a plurality of flexibly connected ultrasound transducer elements on the body surface of the patient; and
using the ultrasound transducer elements to deliver ultrasound to at least a portion of the patient's body for sufficient time to cause the ultrasound-induced effect.

10. A method according to claim 9 wherein the step of using the ultrasound transducer elements comprises radiating ultrasound into the patient's body for a time period of at least about one hour.

11. A method according to claim 9 wherein the ultrasound has a frequency in the range of about 1.6 MHz to about 8 MHz.

12. A method according to claim 9 wherein the ultrasound has a frequency in the range of about 40 KHz to about 400 KHz.

13. A method according to claim 9 wherein the all of the transducer elements emit ultrasound of substantially the same frequency.

14. A method according to claim 9 wherein the frequency of ultrasound emitted by at least one of the transducer elements is different from the frequency of ultrasound that that is emitted from at least one of the other transducer elements.

15. A method according to claim 9 wherein all of the transducer elements emit ultrasound during the same time period.

16. A method according to claim 9 wherein at least one of the transducer elements emits ultrasound during a time period that is different from the time period during which at least one of the other transducer elements emits ultrasound.

17. A method according to claim 9 wherein the ultrasound-induced effect is angiogenesis and/or treatment or prevention of ischemia.

18. A method according to claim 9 wherein the ultrasound device is positioned on the chest and used to promote angiogenesis in the heart for relief of myocardial ischemia.

19. A method according to claim 9 wherein the ultrasound device is used to cause thrombolysis in the patient.

20. A method according to claim 9 wherein the patient is presenting with ST segment changes or other clinical or biochemical indicia of myocardial infarction.

21. A method according to claim 9 wherein the ultrasound device is used to prevent restenosis after angioplasty and/or stent placement in a coronary artery or other vessel.

22. A method according to claim 9 wherein the ultrasound device is positioned on the patient's calf and used to promote angiogenesis, relieve myocardial ischemia and/or intermittent claudication or other ischemic condition of the leg.

23. A method according to claim 9 wherein the ultrasound device is positioned on the chest of a patient who suffers from dilated cardiomyopathy and used to promote angiogenesis and/or improve left ventricular function.

24. A method according to claim 9 wherein the ultrasound device is positioned on at least one extremity of a patient who suffers from diabetic neuropathy or other neuropathy and used to promote angiogenesis and /or relieve pain resulting from such neuropathy.

25. A method according to claim 9 wherein the step of using the ultrasound transducer elements comprises radiating ultrasound energy from more than one of the transducer elements simultaneously.

26. A method according to claim 9 wherein the step of using the ultrasound transducer elements comprises radiating ultrasound energy from each of the transducer elements in an alternating manner.

27. A method according to claim 9 wherein the step of using the ultrasound transducer elements comprises radiating ultrasound energy into the patient's body in a preprogrammed sequence.
